(19) United States
(12) Patent Application Publication
(10) Pub. No.: US 2002/0093999 A1
(43) Pub. Date: Jul. 18, 2002

(54) Laser diode drive circuit and optical transmission system

(76) Inventor: Takayuki Tanaka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/944,123

(22) Filed: Sep. 4, 2001

(30) Foreign Application Priority Data
Jan. 15, 2001 (JP) JP2001-6160

(51) Int. Cl. H01S 3/13; H01S 3/00

(52) U.S. Cl. 372/38.01

(57) ABSTRACT

A laser diode drive circuit and an optical transmission system that are capable of achieving compensation for degradation occurring as a result of a rapid change in the ambient temperature or an operation performed over an extended period of time are provided. The laser diode drive circuit having a temperature compensation circuit 117 further comprises a device that stores in memory a signal from a monitor photodiode 125 as light output power data and a device that implements automatic control on degradation compensation or temperature compensation for a laser diode 112 by using the light output power data as a reference voltage.

### CROSS-REFERENCE TO RELATED APPLICATION

This application claims the priority benefit of Japanese Patent Application No. 2001-6160, filed Jan. 15, 2001, the entire disclosure of which is incorporated herein by reference.

### BACKGROUND OF THE INVENTION

1. Field of the Invention

The present invention relates to a laser diode drive circuit and an optical transmission system and, more specifically, it relates to a laser diode drive circuit having a temperature compensation circuit and an optical transmission system.

2. Description of the Related Art

In a standard laser diode drive circuit in the conventional art, the operation is performed by adopting one of the two methods described below. The following is an explanation of laser diode drive circuits in the conventional art. One type of laser diode drive circuit adopts the zero bias drive method achieved without supplying a preliminary DC bias current to the laser diode, and another type of laser diode drive circuit adopts the bias drive method achieved by supplying a preliminary DC bias current to the laser diode.

In a laser drive circuit adopting the zero bias drive method in which no preliminary DC bias current is supplied, an input signal is re-timed at a D-flip-flop to turn on/off a current switch circuit and a drive current Ip is made electrically continuous to either the laser diode or a resister R. As a result, light emission/extinction occurs at the laser diode and an optical signal corresponding to the input signal is output.

The level of the drive current Ip, which determines the level of the light output power from the laser diode is controlled by varying the base potential at a transistor Tr connected to the current switch.

In addition, the control on the base potential is achieved through a temperature compensation circuit. Namely, the present ambient temperature is first detected by a temperature sensor, digital data matching the ambient temperature are called up from an internal data storage unit, in which data are stored in correspondence to ambient temperatures and the digital data thus extracted are converted to an analog voltage value through D/A conversion.

This analog voltage value is input to a non-inversion input terminal of an operational amplifier and is used as the base potential of the transistor Tr. The emitter potential VE of the transistor Tr becomes lowered by VBE and the lowered potential is input to an inversion input terminal of the operational amplifier. Through the negative feedback loop constituted by the operational amplifier and the transistor Tr, the modulation current Ip of the laser diode becomes fixed at a constant level in correspondence to a reference voltage VE and the value at the resister R and, as a result, the light output power, too, becomes fixed at a constant level. Through this temperature compensation control method, the modulation current Ip corresponding to the ambient temperature is made electrically continuous to the laser diode.

In addition, when it is necessary to supply a preliminary DC bias current Ib in correspondence to the type of laser diode in use, a method similar to the control implemented on the modulations side may be adopted.

However, if the ambient temperature fluctuates, the values of the modulation current Ip and the DC bias current Ib may become incorrect due to the difference between the temperature at the laser diode and the temperature detected by the temperature sensor in the conventional art. If the value of the modulation current Ip is incorrect, the level of the light output power will become deviated from the standard value range stipulated in the specification, whereas if the value of the DC bias current Ib is incorrect, a problem related to the extinction ratio will occur.

Furthermore, due to the deterioration occurring over time in the threshold current and the efficiency in the light emission differentiation at the laser diode, the data stored in advance become inapplicable. This leads to a problem in that degradation occurs caused by a rapid change in the ambient temperature or an operation performed over an extended period of time for which sufficient compensation cannot be achieved.

### SUMMARY OF THE INVENTION

Accordingly, an object of the present invention is to provide a new and improved laser diode drive circuit and a new and improved optical transmission system, that are capable of achieving compensation for degradation caused by a rapid change in the ambient temperature or an operation performed over an extended period of time.

In order to achieve the object described above, in a mode that represents the present invention, a laser diode drive circuit having a temperature compensation circuit, which further comprises a device that stores in memory a signal output from a monitor photodiode as light output power data and a device that implements automatic control on degradation compensation or temperature compensation for the laser diode by using the light output power data as a reference voltage, is provided.

Since the level of the drive current Ip for the laser diode is controlled in correspondence to the differential voltage from the data storage unit and the monitor photodiode, stable light output power is obtained even when the laser diode becomes degraded over time in addition to achieving temperature compensation. As a result, the performance of the optical transmission system improves.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is a block diagram of the laser diode drive circuit achieved in a first embodiment;

FIG. 2 is a block diagram of the laser diode drive circuit achieved in a second embodiment;

FIG. 3 is a block diagram illustrating the structure adopted in the optical transmission system achieved in a third embodiment; and

FIG. 4 is a flowchart of the operation achieved in the optical transmission system in the third embodiment.

### DETAILED DESCRIPTION OF THE PREFERRED EMBODIMENTS

The following is a detailed explanation of the preferred embodiments of the present invention, given in reference to the attached drawings. It is to be noted that in the following explanation and the attached drawings, the same reference numerals are assigned to components achieving identical functions and structural features to preclude the necessity for a repeated explanation thereof.

(First Embodiment)

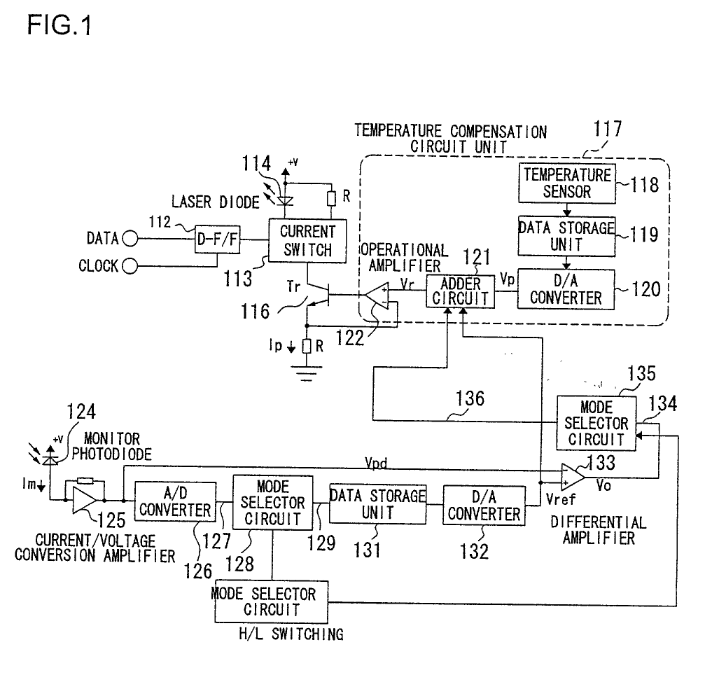

The following is an explanation of the first embodiment given in reference to FIG. 1, which is a block diagram of the laser diode drive circuit achieved in the embodiment.

First, as illustrated in FIG. 1, the laser diode control circuit in the embodiment is constituted by providing a monitor photodiode 124, a current/voltage conversion amplifier 125, an A/D conversion circuit 126, a first mode selector circuit 128, a data storage unit 131, a differential amplifier 133, an adder circuit 121 and the like, in addition to the components of the drive circuit achieved in the conventional art.

Now, the operation achieved in the laser diode drive circuit structured as described above is explained.

An operation to achieve mode setting 1 is performed at the first mode selector circuit 128. First, the first mode selector circuit 128 is set so as to short a first wiring 127 and a second wiring 129. Likewise, a second mode selector circuit 135 is set so as to open a third wiring 134 and a fourth wiring 136. Following this modes setting, a temperature compensation unit 117 in the laser diode drive circuit is set.

By using specific data stored in correspondence to a given temperature level at a data storage unit 119 in the temperature compensation circuit 117 provided in the laser diode drive circuit, a specific level of light output power is obtained. This operation is referred to as operation 1. The operation 1 is explained below.

During operation 1, after achieving re-timing at a D-flip-flop 112, data and a clock are input to a current switch unit 113. During this process, an operational amplifier 122 is driven via a D/A converter 120 by the data stored in the data storage unit 119 and, as a result, a electric current flows to a transistor Tr 116. By storing correct data at the data storage unit 119, a specific level of light output power is obtained at a laser diode 114.

The light output from the laser diode 114 is transmitted to the transmission path via an optical fiber. At the same time, the back light of the laser diode 114 is input to the monitor photodiode 124. This back light generates a photocurrent Im, which is then converted to a voltage at the current/voltage conversion amplifier 125, and the corresponding data are stored at the data storage unit 131 via the A/D conversion circuit 126.

This operation 1 may be executed at a predetermined temperature setting (e.g., room temperature). Since a specific photocurrent can be obtained as data as long as a specific light output is achieved at a given temperature within the temperature setting range, it is not necessary to detect the temperature by employing a temperature sensor at the data storage unit 131. When operation 1 is completed, mode settings 2 is implemented.

During mode setting 2, the first mode selector circuit 128 is set so as to open the first wiring 127 and the second wiring 129 and the second mode selector circuit 135 is set so as to short the third wiring 134 and the fourth wiring 136, by reversing mode setting 1 explained earlier. Thus, operation 2 is enabled in the laser diode drive circuit. It is to be noted that operation 2 refers to a normal operation.

During operation 2, the laser diode 114 is driven to output light. In addition, back light is input to the monitor photodiode 124. The photocurrent Im generated by the back light is input to the differential amplifier 133 as a voltage Vpd via the current/voltage conversion amplifier 125.

The data having been stored through operation 1 are detected from the data storage unit 131, the detected data undergo analog conversion at a D/A converter 132 and the converted data are then input as Vref to the differential amplifier 133. This voltage Vref is used as a reference voltage at the differential amplifier 133.

The differential amplifier 133 amplifies the difference between the reference voltage Vref and Vpd and outputs the amplified difference as a voltage Vo. It is to be noted that the gain at the differential amplifier 133 is determined in conformance to the characteristics of the laser diode and the monitor photodiode.

The output voltage Vo is input to the adder circuit 121. The voltage Vo input to the adder circuit 121 is added to a voltage VP resulting from the conversion performed at the D/A converter 120 in the temperature compensation unit 117.

It is to be noted that the reference voltage used at the adder circuit 121 at this time is Vref. A voltage Vr representing the sum obtained through the addition is input to the non-inversion input terminal of the operational amplifier 122. As a result, the modulation current Ip supplied to the laser diode 114 changes until the value of Vpd at the differential amplifier 133 becomes equal to the Vref value.

Through operation 2 explained above, the difference between Vpd and Vref is input to the adder circuit, Vr input to the operational amplifier is changed accordingly and the modulation current Ip is changed until the light output power from the laser diode achieves the initial value (the value set through operation 1). As a result, the light output power from the laser diode automatically sustains its initial value and maintains stability.

In the embodiment, in which the level of the drive current Ip for the laser diode is controlled by using both the data stored in the data storage unit and the differential voltage provided from the monitor photodiode, achieves stable light output power even when the laser diode becomes degraded over time in addition to achieving temperature compensation. As a result, the performance of the light transmitter improves.

(Second Embodiment)

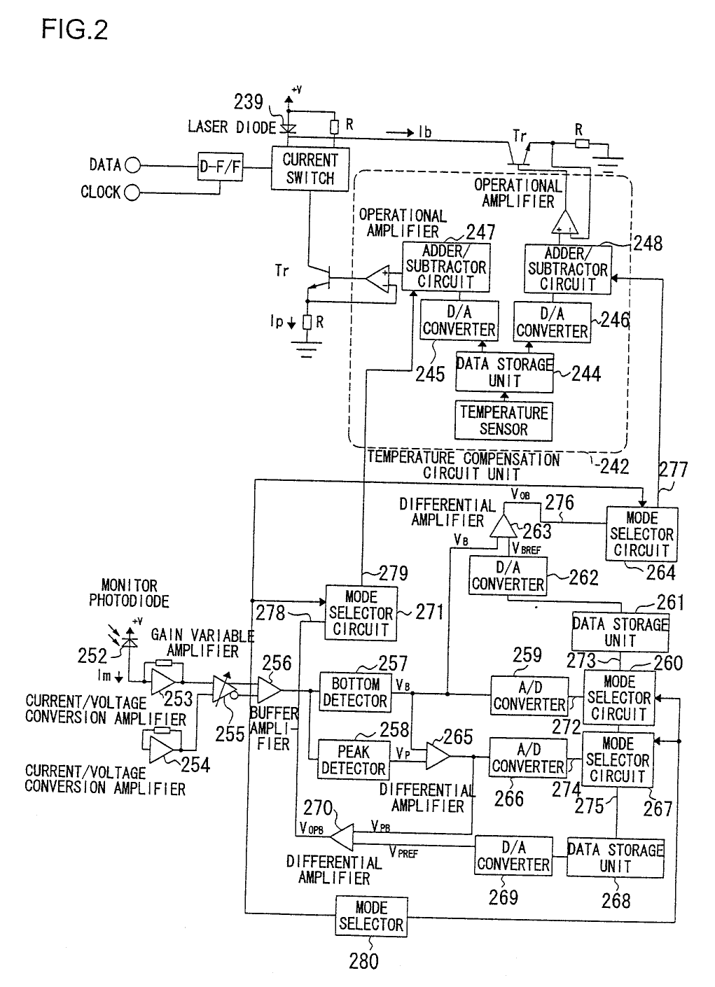

The following is an explanation of the second embodiment given in reference to FIG. 2. FIG. 2 presents a block diagram of the laser diode drive circuit achieved in the second embodiment.

The laser diode drive circuit in the embodiment is constituted by providing a gain variable amplifier, a current/voltage conversion amplifier that supplies a reference voltage to the gain variable amplifier, a buffer amplifier, a bottom detection circuit, a peak detection circuit, an operational amplifier and the like in addition to the components of the drive circuit in the first embodiment. In this circuit, the DC current which is supplied in advance to the laser diode can be controlled as well.

First, mode something 1 is achieved by engaging mode selector circuits 260, 267, 264 and 271. A first mode selector circuit 260 is set so as to short a first wiring 272 and a second wiring 273, and the second mode selector circuit 267 is set so as to short a third wiring 274 and a fourth wiring 275. Likewise, the third mode selector circuit 264 is set so as to open a fifth wiring 276 and a sixth wiring 277 and the fourth mode selector circuit 271 is set so as to open a seventh wiring 278 and an eighth wiring 279.

When mode setting 1 is completed, operation 1 similar to that implemented in the first embodiment is executed to store data in a data storage unit 244 in a temperature compensation unit 242 and the level of the light output power from a laser diode 239 is set. Likewise, the level of a preliminary bias DC current Ib supplied to the laser diode 239 in advance is set.

The back light from the laser diode 239 is detected by a monitor photodiode 252, thereby generating a photocurrent Im. The correct signal is converted into a voltage signal at a current/voltage conversion amplifier 253 and the voltage signal is input to a gain variable amplifier 255 together with the output from another current/voltage conversion amplifier 254 which is used as a reference voltage source.

The bottom value VB and the peak VP of the output signal from the gain variable amplifier 255 are detected by a bottom detection circuit 257 and a peak detection circuit 258 via a buffer amplifier 256. The detected bottom value undergoes A/D conversion at an A/D converter 259 and the converted data are stored in a data storage unit 261. At the same time, a voltage VPB representing the difference between the peak value and the bottom value is extracted at a differential amplifier 265, and the data obtained by implementing A/D conversion on the voltage VPB at an A/D converter 266 are stored in a data storage unit 268. This operation may be executed at a predetermined temperature as in the first embodiment. When operation 1 is completed, operation 2 is enabled through mode setting 2.

Mode setting 2 is achieved by engaging the various mode selector circuits 260, 267, 264 and 271. The first mode selector circuits 260 is set so as to open the first wiring 272 and the second wiring 273, and the second mode selector circuit 267 is set so as to open the third wiring 274 and the fourth wiring 275. Likewise, the third mode selector circuit 264 is set so as to short the fifth wiring 276 and the sixth wiring 277 and the fourth mode selector circuit 271 is set so as to short the seventh wiring 278 and the eighth wiring 279. Thus, operation 2 is enabled in the laser diode drive circuit. It is to be noted that operation 2 corresponds to a normal state.

As the laser diode 239 is driven and its back light is input to the monitor photodiode 252, the photocurrent Im is generated. The bottom value VB and the peak value VP of the photocurrent Im are detected by the bottom detection circuit 257 and the peak detection circuit 258 via the current/voltage conversion amplifier 253, the gain variable amplifier 255 and the buffer amplifier 256.

The digital data having been stored through operation 1 in the data storage unit 261 are converted to an analog value at a D/A converter 262 and the converted data are input to a differential amplifier 263 as a reference voltage VBREF, together with the bottom value VB. A voltage VOB representing the difference between the reference voltage VBREF and the bottom value VB is extracted and input to an adder subtractor circuit 248. It is to be noted that the adder circuit 248 uses VBREF as the reference voltage.

The difference between the peak value and the bottom value is extracted at the differential amplifier 265 and the difference is input as a voltage VPB at one phase of a differential amplifier 270 provided at the following stage. The data having been stored in the data storage unit 268 through operation 1 are input at the other phase of the differential amplifier 270 as a voltage VPREF via a D/A converter 269. At the differential amplifier 270, a voltage VOPB representing the difference between VPB and the voltage VPREF is extracted and then input to an adder circuit. The adder circuit uses VPREF as a reference voltage.

VOB and VOPB having been input to the adder subtractor circuits 248 and 247 are added to the value resulting from a D/A conversion 246 and the value resulting from a D/A conversion 245 respectively until the individual voltages become equalized at the differential amplifiers 263 and 270. Thus, the light output power is allowed to sustain its initial value and thus maintains stability by changing the DC bias current and the modulation current supplied to the laser diode.

As described above, advantages similar to those in the first embodiment are achieved with regard to the extinction ratio of the DC bias current in addition to the advantages realized in the first embodiment, to further improve the performance of the light transmitter.

(Third Embodiment)

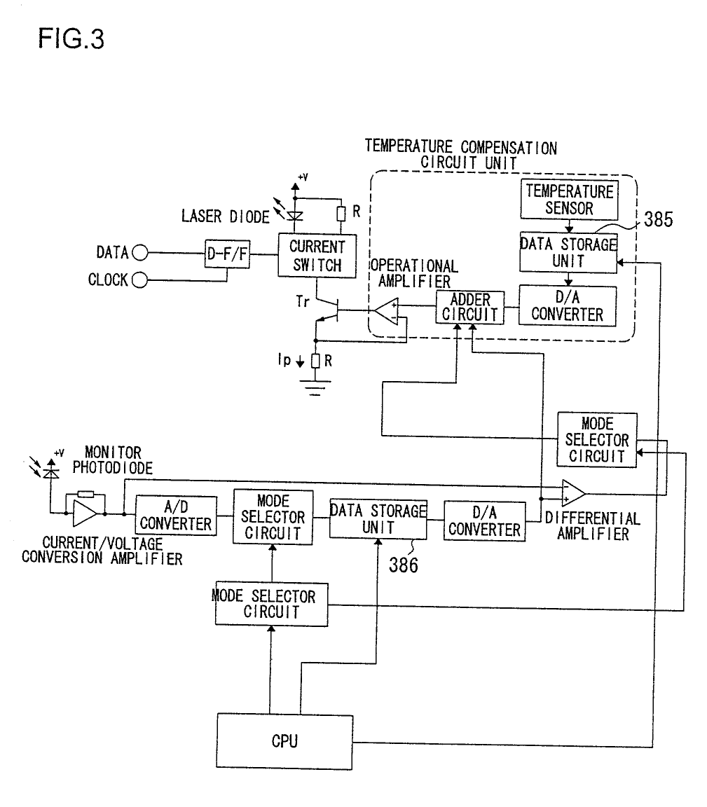

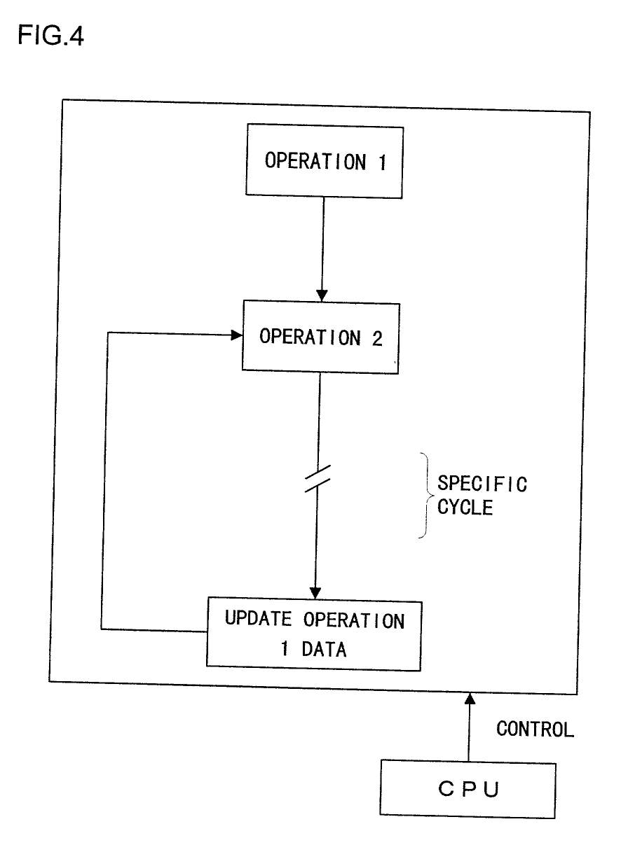

Next, in reference to FIGS. 3 and 4, the third embodiment is explained. FIG. 3 is a block diagram illustrating the structure adopted in the optical transmission system achieved in the third embodiment.

In the optical transmission system in the embodiment, the mode selector circuits and the data storage units in the laser diode drive circuit in the first or second embodiment are controlled by an external CPU. In the embodiment, the data in data storage units 385 and 386 are regularly updated. In addition, the mode selector circuits, too, are switched by the CPU through automatic control.

Next, the flow of the operation achieved in the optical transmission system in the embodiment is explained in reference to FIG. 4. FIG. 4 is a flowchart of the operation achieved in the optical transmission system in the embodiment.

As shown in FIG. 4, when operation 1 is completed, the system shifts to operation 2 which is a normal operation, and after a specific cycle, the data in the data storage units are updated.

The laser diode drive circuit according to the present invention may be adopted in An optical transmission system having An optical transmission circuit that converts an electrical signal to a light signal and transmits the converted signal. In addition, application of the present invention is not limited to an optical transmission system and may be adopted to achieve temperature compensation and degradation compensation for any circuit that converts an electrical signal to a light signal by using a laser diode as well as in An optical transmission system.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

Since the level of the drive current Ip for the laser diode is controlled by using both the data in the data storage units and the differential voltage supplied from the monitor photodiode, light output power which remains stable in spite of degradation occurring in the laser diode over time is achieved as well as achieving temperature compensation, to contribute to an improvement in the performance of a light transmitter.

What is claimed is:

1. A laser diode drive circuit comprising;
a temperature compensation circuit;
a device that stores in memory a signal from a monitor photodiode as light output power data; and
a device that implements automatic control on temperature compensation and degradation compensation for said laser diode by using said light output power data as a reference voltage.

2. A laser diode drive circuit according to claim 1, wherein;
a light power output data value having been stored in said storage device is regularly updated by a specific control device.

3. A laser diode drive circuit according to claim 1, wherein;
said degradation compensation is achieved for said laser diode by changing a modulation current flowing through said laser diode so as to match the level of the light output power from said laser diode with said light power output data value stored in said storage device.

4. A laser diode drive circuit according to claim 3, wherein;
a light power output data value having been stored in said storage device is regularly updated by a specific control device.

5. A laser diode drive circuit comprising;
a temperature compensation circuit;
an amplitude detection circuit constituted of a bottom detection circuit, a peak detection circuit and a differential amplifier; and
a device that stores in memory a signal provided by a monitor photodiode as light output power data wherein;
said amplitude detection circuit implements automatic control on temperature compensation, degradation compensation and extinction ratio compensation by using said light output power data as a reference voltage.

6. A laser diode drive circuit according to claim 5, wherein;
a light power output data value having been stored in said storage device is regularly updated by a specific control device.

7. A laser diode drive circuit according to claim 5, wherein;
said degradation compensation is achieved for said laser diode by changing a modulation current flowing through said laser diode so as to match the level of the light output power from said laser diode with said light power output data value stored in said storage device.

8. A laser diode drive circuit according to claim 7, wherein;
a light power output data value having been stored in said storage device is regularly updated by a specific control device.

9. A laser diode drive circuit according to claim 7, wherein;
said extinction ratio compensation is achieved for said laser diode by changing a DC bias current flowing through said laser diode so as to match the level of the light output power from said laser diode with said light power output data value stored in said storage device.

10. A laser diode drive circuit according to claim 9, wherein;
a light power output data value having been stored in said storage device is regularly updated by a specific control device.

11. An optical transmission system comprising;
a laser diode drive circuit according to claim 1; and
a control device that implements control on said laser diode drive circuit according to claim 1, wherein;
said control device regularly updates data in a data storage unit.

12. An optical transmission system comprising;
a laser diode drive circuit according to claim 3; and
a control device that implements control said laser diode drive circuit according to claim 3, wherein;
said control device regularly updates data in a data storage unit.

13. An optical transmission system comprising;
a laser diode drive circuit according to claim 5; and
a control device that implements control on said laser diode drive circuit according to claim 5, wherein;
said control device regularly updates data in a data storage unit.

14. An optical transmission system comprising;
a laser diode drive circuit according to claim 7; and
a control device that implements control on said laser diode drive circuit according to claim 7, wherein;
said control device regularly updates data in a data storage unit.

15. An optical transmission system comprising;
a laser diode drive circuit according to claim 9; and
a control device that implements control on said laser diode drive circuit according to claim 9, wherein;
said control device regularly updates data in a data storage unit.
